(19) United States
(12) Patent Application Publication
(10) Pub. No.: US 2004/0181544 A1
(43) Pub. Date: Sep. 16, 2004

(54) Schema server object model

(75) Inventor: Breanna Daphne Anderson, Bothell, WA (US)

Correspondence Address: MERCHANT & GOULD PC, P.O. BOX 2903, MINNEAPOLIS, MN, 55402-0903, US

(73) Assignee: SchemaLogic

(21) Appl. No.: 10/739,911

(22) Filed: Dec. 18, 2003

Related U.S. Application Data
(60) Provisional application No. 60/434,535, filed on Dec. 18, 2002.

(51) Int. Cl. G06F 17/00

(52) U.S. Cl. 707/102

(57) ABSTRACT

A schema model allows objects to be contextualized by using stored values that are used to localize the object. The values used for localizing each object that is to be localized are stored in a container class element that is associated with the object that is to be localized. The object having localized term values stored in a container class element is related to another object wherein the objects are related using one of a hierarchical term and an entry term relationship. The associate values allow a user to override by redefinition default values presented by a controlled vocabulary system. The user can further relate term objects by using hierarchical-, entry-, and related-term relationships. This arrangement allows users and systems to more effectively re-use standard data definitions.

### RELATED APPLICATION

This application claims the benefit of U.S. Provisional Application No. 60/434,535, filed Dec. 18, 2002, the benefit of the earlier filing date of which is hereby claimed under 35 U.S.C. § 119 (e).

### FIELD OF THE INVENTION

The present invention is related to software, and more specifically to contextualizing schemas using differing relational types.

### BACKGROUND OF THE INVENTION

Attempts to access and share information across disparate systems are limited by inconsistent organizational naming and data standards. It is very difficult to have a collaborative software infrastructure to create information access and sharing standards across existing systems by managing disparate taxonomies and metadata models.

Many technologies have tried to solve basic information integration problems, but have not had great success. Deployments of integration technologies have not measured up to their intended return in part because the technology relies on organizational standards to be well adopted and assumes that naming standards are unchanging.

In reality, standards rarely exist, have limited adoption, and are subject to change. What is needed is a way to solve the problem of creating and maintaining disparate systems using schema objects that are easily manipulated by users.

### SUMMARY OF THE INVENTION

Briefly described, a schema model allows objects to be contextualized by using stored values that are used to localize the object. The values used for localizing each object that is to be localized are stored in a container class element that is associated with the object that is to be localized. The object having localized term values stored in a container class element is related to another object wherein the objects are related using one of a hierarchical term and an entry term relationship. The associated values allow a user to override by redefinition default values presented by a controlled vocabulary system. The user can further relate term objects by using hierarchical term, entry term, and related-term relationships. This arrangement allows users and systems to more effectively re-use standard data definitions.

### BRIEF DESCRIPTION OF THE DRAWINGS

FIGS. 1-3 show components of an exemplary environment in which the invention may be practiced.

FIG. 4 is a schematic diagram of an example Schema Server Object Model, in accordance with the present invention.

FIG. 5 is a schematic diagram showing a conventional vocabulary localization using entry terms.

FIG. 6 is a schematic diagram showing an intrinsic vocabulary localization mechanism using entry terms, in accordance with the present invention.

FIG. 7 is a schematic diagram showing a term relationship of one to many, in accordance with the present invention.

FIG. 8 is a schematic diagram of two example structures that illustrate term relationships.

FIG. 9 is a schematic diagram three classes of term relationship types, in accordance with the present invention.

FIG. 10 is a schematic diagram of an example application of a Schema Server Object Model, in accordance with the present invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means a direct electrical connection between the items connected, without any intermediate devices. The term “coupled” means either a direct electrical connection between the items connected or an indirect connection through one or more passive or active intermediary devices.

Definition of Terms

Table 1 includes definitions for terms related to the present invention.

TABLE 1

| Terminology | Definition and common synonyms or similar concepts |
|---|---|
| Change Management | Schema Servers workflow process for ensuring that changes to Schema Objects |
| | are approved by the impacted constituencies with adequate notice and process |
| | such that subscribing systems will not be unduly negatively impacted. |
| Content Class | A schema structure definition object made up of a list of element type references. |
| | Content Classes define schema structures that may be nested in other classes or |
| | may represent stand-alone schema structures that define document, product, user |
| | or other structures or metadata structures associated with such knowledge |
| | resources. |
| Content Management | A structured data repository system for managing information assets, often in a |
| | generalized database server with emphasis on repurposing. |
| | Content Management (CM) systems are distinguished from |
| | Document Management systems in that CM systems often use structured |
| | databases to store both the data and the metadata often in the same or similar |
| | structures. |
| Element (Type) | A schema object that defines a metadata tagging field or sub-structure. |
| | ElementTypes are often simply called “Elements” for shorthand particularly in the |
| | SchemaServer administrative user interface. Examples: Title (string), Quantity |
| | (int), Product (vocabulary), Milestone (class) |
| Enumerated List | Generally, a simple vocabulary represented as a flat list. This is often used to |
| | supply values for “Drop Down” menus or pick lists, but may also used as |
| | authority lists, or any other time when referential integrity dictates their usage. |
| Hierarchy | Nested or recursive (tree structured) object collections. |
| | A hierarchy always begins with a single “root” object (or node). Each node may |
| | have zero or more “child” nodes associated with it. Each of those child nodes |
| | may have zero or more child nodes and so on. In a simple hierarchy, each node |
| | may appear only once in the tree consequently, there is one “path” from any node, |
| | through its parent and ancestors to the root node. Hierarchies are useful structures |
| | to describe concepts like company reporting structures, or plant taxonomies. |
| Impact Analysis | The process of determining the objects and users in the SchemaServer repository |
| | that will be impacted (modified or changed) when the specified schema object is |
| | added or updated. |
| Inherit(ance) | To posses a characteristic by transmission from a parent or more distantly |
| | removed ancestor. |
| | The technique of inheritance is used in the Content Class hierarchy tree to pass on |
| | inclusion of inherited ElementTypes. For example, if the class “Core” includes |
| | the ElementType “Author” and “PublishedDate”, then the descendent classes also |
| | include “Author” and “PublishedDate”. If the ElementType “PublishedDate” is |
| | removed from class “Core” then it disappears from the descendant classes. |
| | Inheritance is also used to manage allocation of permissions in a Vocabulary tree. |
| Localize(able) | To translate into a diferent language. |
| | Localizable: to provide features that enable localization. |
| | ElementTypes and Terms include structures that allow an extensive list of |
| | alternate language translations to be stored. SchemaServer APIs include options |
| | for extracting versions of structures in any selected language for which the data |
| | has been localized. |
| MetaData | Data-About-Data (literally: hidden data). |
| | Metadata are typically pieces of information that describe a file-based document |
| | or other digitally or sometimes physically stored object for purposes of retrieval or |
| | description. Metadata is often indexed to improve the speed and availability of |
| | document or information retrieval. Sometimes metadata is difficult to |
| | discriminate from data and the distinction is academic and subjective. |
| Permission | The mechanism for granting users special rights to individual Schema Objects. |
| | Permissions are Owner, Stakeholder and Subscriber. See Permission and |
| | workflow management for more details. |
| Poly-Hierarchy | Poly-hierarchies are like hierarchies except that any given node may appear at |
| | multiple places in the tree, except that a node cannot be its own ancestor. Poly- |
| | hierarchies are useful when classifications are not absolute. For example, in a |
| | hierarchy of vehicle types, a seaplane is a descendant of both the “Watercraft” and |
| | “Aircraft” categories. Schema Server vocabularies may include poly-hierarchies. |
| Resource (knowledge | A generic term most commonly used in this document for a knowledge asset with |
| resource) | which metadata is associated. |
| | A resource may be an on-disk file of any time or function or a database record or |
| | even a physical asset stored on a shelf or in a filing cabinet as long as there is a |
| | unique retrieval identifier attached to it so that it may be recovered reliably. |
| Schema | Rules and specifications for the consistent application of metadata. |
| | To make metadata useful, it should be applied in a consistent manner. A schema |
| | is often simply a list of named metadata fields, (alternatively called elements, |
| | attributes or properties), that may or must appear and controls on what can appear |
| | on those fields: e.g. strings, dates, number, a selection of one or more values from |
| | a list of approved values. |
| (Schema) Object | A schema structure managed by Schema Server which has a persistent object |
| | identifier GUID, can be permission controlled and versioned. |
| | First-order Schema objects are: Content Classes, ElementTypes, Vocabularies, |
| | Terms and Vocabulary Views. Secondary Schema Objects are: |
| | TermRelationships, TermRelationship Types, |
| Taxonomy | A scheme for categorizing information |
| | Taxonomy comes from the Greek for “structure or arrangement”. Some of the |
| | most venerable and notable taxonomies are for categorizing plants or animals into |
| | kingdoms, phylum, class, order, family, genus, and species. |
| | When used in this document, it means either a vocabulary (a specific classification |
| | domain) or it is used in a colloquial sense for schema as apparent by context. |
| Term | An approved metadata value that can be used to tag content. Terms are structured |
| | into vocabularies but a term may appear in multiple vocabularies where |
| | appropriate. Schema Server terms are complex objects including an immutable |
| | GUID identifier, description, annotation and localization information. |
| Term Relationship | A connective schema object that associates one term to another in the context of a |
| | vocabulary qualified by a type that describes the nature of the relationship. |
| | Terms are made part of a vocabulary by virtue of term relationships. Term |
| | relationships are typed according to an extensible scheme of “Term Relationship |
| | Types” (see below), which provide business rules for vocabulary construction and |
| | advanced vocabulary filtering capabilities. |
| Term Relationship Type | A qualifying type for term relationships that carries business |
| | rules, description information about the nature of inter-term relationships. |
| | See Schema Server concepts for more detail. |
| Thesaurus | A form of a vocabulary that may be presented as a hierarchy or poly-hierarchy. A |
| | thesaurus may also support different types of term relationships (Entry term or |
| | Related Term are two potential types of relationships). |
| User | An identifiable human operator having a registered name, login identifiers, |
| | passwords and email addresses. Schema Server users create and manage |
| | schemas. |
| Vocabulary | A structured collection of metadata Terms (see Term below). A vocabulary is a |
| | first order Schema Object including a name, description, immutable GUID |
| | identifier and can be workflowed. Vocabularies can be structured as simple lists |
| | of terms but can also be structured as extensive hierarchies to simplify |
| | management and provide for more powerful reuse. |
| | Enumerated lists, Taxonomies, Authority lists, and Thesauri, are examples of |
| | structures that can be created as Vocabularies in Schema Server. |
| Workflow | The intentional process involving users that controls the addition, modification or |
| | deletion of schema objects. |
| | To distinguish this kind of process from workflow having to do with actual |
| | knowledge assets (documents etc), the term “Change Management” is sometimes |
| | used. |

Exemplary Operating Environment

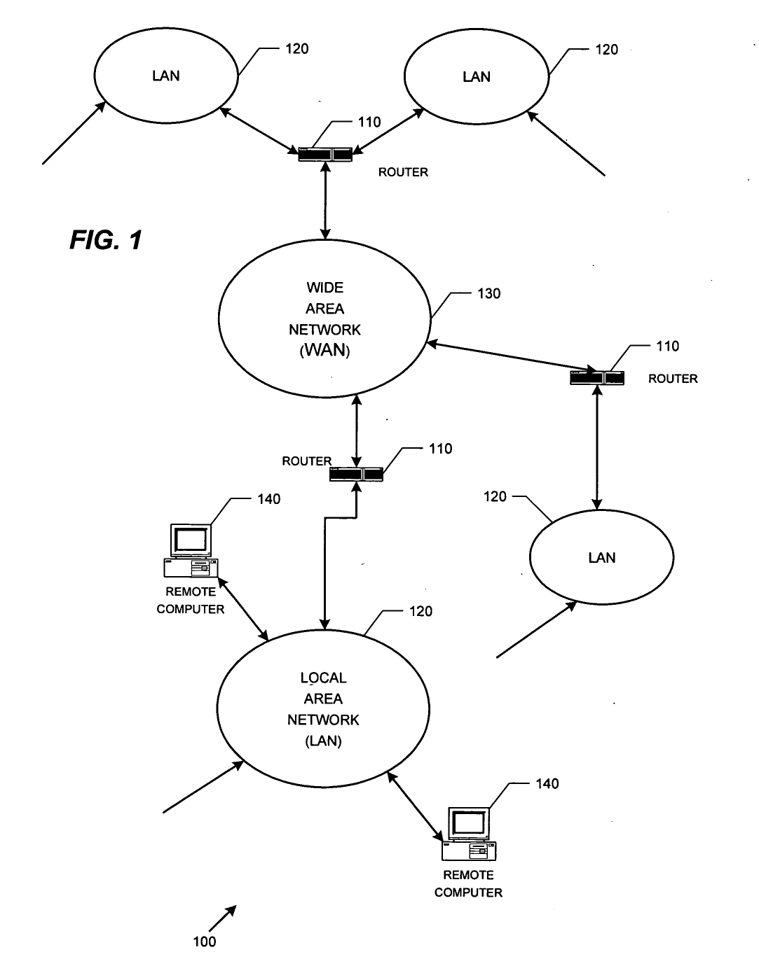

FIGS. 1-3 show components of an exemplary environment in which the invention may be practiced. Not all of the components may be required to practice the invention, and variations in the arrangement and type of the components may be made without departing from the spirit or scope of the invention.

FIG. 1 shows a plurality of local area networks (“LANs”) 120 and wide area network (“WAN”) 130 interconnected by routers 110. On a single network linking many computers through a mesh of possible connections, a router receives transmitted messages and forwards them to their correct destinations over available routes. On an interconnected set of LANs—including those based on differing architectures and protocols—a router acts as a link between LANs, enabling messages to be sent from one to another. Communication links within LANs typically include twisted pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links known to those skilled in the art. Furthermore, computers, such as remote computer 140, and other related electronic devices can be remotely connected to either LANs 120 or WAN 130 via a modem and temporary telephone link. The number of WANs, LANs, and routers in FIG. 1 may be increased or decreased arbitrarily without departing from the spirit or scope of this invention.

The media used to transmit information in communication links illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

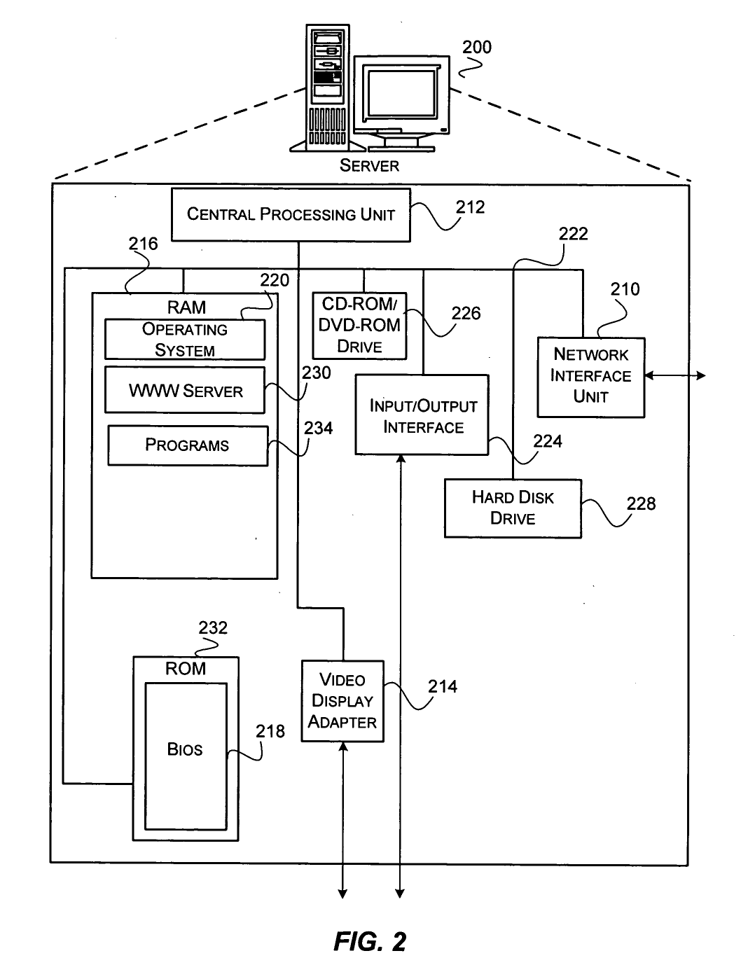

A server, such as the server shown in FIG. 2, may provide a WWW site, be a content server, a schema server, an authentication server, etc.

FIG. 2 shows an exemplary server in accordance with aspects of the invention. Server 200 may include many more components than those shown in FIG. 2. As shown in FIG. 2, server 200 is connected to WAN/LAN 100, or other communications network, via network interface unit 210. Network interface unit 210 includes the necessary circuitry for connecting server 200 to WAN/LAN 100, and is constructed for use with various communication protocols including the TCP/IP protocol. Typically, network interface unit 210 is a card contained within server 200.

Server 200 also includes processing unit 212, video display adapter 214, and a mass memory, all connected via bus 222. The mass memory generally includes random access memory (“RAM”) 216, read-only memory (“ROM”) 232, and one or more permanent mass storage devices, such as hard disk drive 228, a tape drive (not shown), optical drive 226, such as a CD-ROM/DVD-ROM drive, and/or a floppy disk drive (not shown). The mass memory stores operating system 220 for controlling the operation of server 200. This component may comprise a general purpose server operating system as is known to those of ordinary skill in the art, such as UNIX, LINUX™, or Microsoft WINDOWS NT®. Basic input/output system (“BIOS”) 218 is also provided for controlling the low-level operation of server 200.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory may also store program code and data for providing a WWW site. More specifically, the mass memory may store applications including server application program 230, and programs 234.

Server 200 also comprises input/output interface 224 for communicating with external devices, such as a mouse, keyboard, scanner, or other input devices not shown in FIG. 2. Likewise, server 200 may further comprise additional mass storage facilities such as optical drive 226 and hard disk drive 228. Hard disk drive 228 is utilized by server 200 to store, among other things, application programs, databases, and program data used by server application program 230. For example, schemas, customer databases, product databases, image databases, and relational databases may be stored.

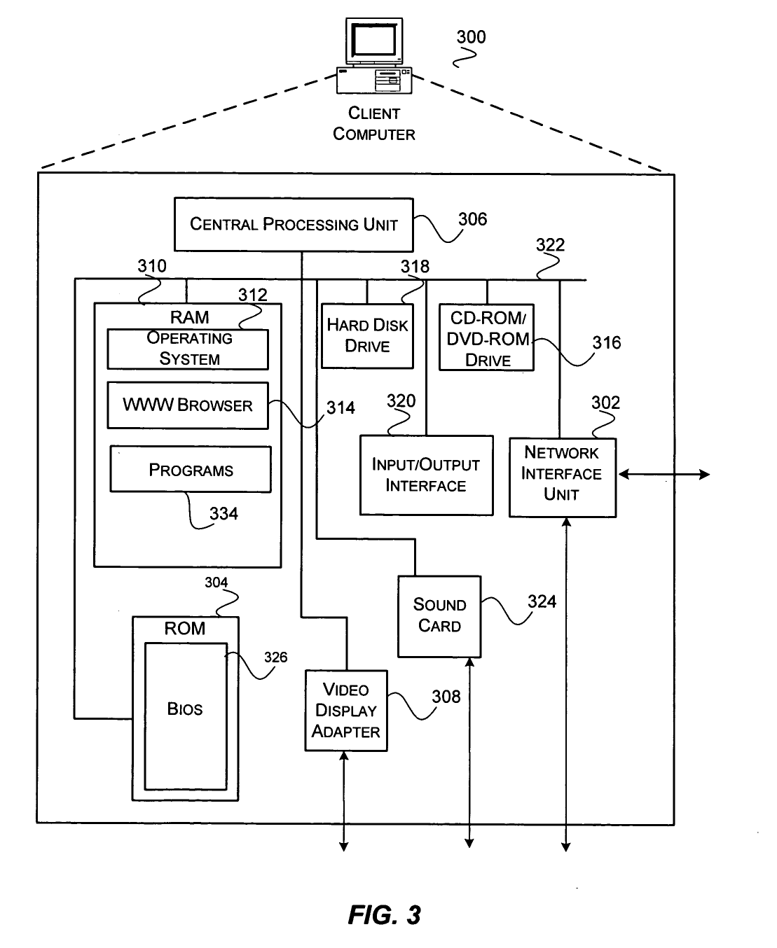

FIG. 3 depicts several components of client computer 300. Client computer 300 may include many more components than those shown in FIG. 3. However, it is not necessary that those conventional components be shown in order to disclose an illustrative embodiment for practicing the present invention. As shown in FIG. 3, client computer 300 includes network interface unit 302 for connecting to a LAN or WAN, or for connecting remotely to a LAN or WAN. Network interface unit 302 includes the necessary circuitry for such a connection, and is also constructed for use with various communication protocols including the TCP/IP protocol, the particular network configuration of the LAN or WAN it is connecting to, and a particular type of coupling medium. Network interface unit 302 may also be capable of connecting to the Internet through a point-to-point protocol (“PPP”) connection or a serial line Internet protocol (“SLIP”) connection as known to those skilled in the art.

Client computer 300 also includes BIOS 326, processing unit 306, video display adapter 308, and memory. The memory generally includes RAM 310, ROM 304, and a permanent mass storage device, such as a disk drive. The memory stores operating system 312 and programs 334 for controlling the operation of client computer 300. The memory also includes WWW browser 314, such as Netscape's NAVIGATOR® or Microsoft's INTERNET EXPLORER® browsers, for accessing the WWW. It will be appreciated that these components may be stored on a computer-readable medium and loaded into memory of client computer 300 using a drive mechanism associated with the computer-readable medium, such as a floppy disk drive (not shown), optical drive 316, such as a CD-ROM/DVD-ROM drive, and/or hard disk drive 318. Input/output interface 320 may also be provided for receiving input from a mouse, keyboard, or other input device. The memory, network interface unit 302, video display adapter 308, and input/output interface 320 are all connected to processing unit 306 via bus 322. Other peripherals may also be connected to processing unit 306 in a similar manner.

As will be recognized from the discussion below, aspects of the invention may be embodied on server 200, on client computer 300, or on some combination thereof. For example, programming steps may be contained in programs 334 and/or programs 234.

In this disclosure, references will be made to client and server. Where appropriate, client should be construed to refer to a process or set of processes that execute on one or more electronic device, such as client computer 300 of FIG. 3. A client is not limited, however, to running on a client computer. It may also run on a server, such as server 200 or be distributed among various electronic devices, wherein each device might contain one or more processes or routines that together constitute a client application. Where appropriate, client should be construed, in addition or in lieu of the discussion above, to be a device upon which one or more client processes execute, for example, client computer 300 or server 200.

Similarly, server should be construed to refer to a process or set of processes that execute on one or more electronic devices, such as server 200. Like a client, a server is not limited to running on a server computer. Rather, it may also execute on what would typically be considered a client computer, such as client computer 300 of FIG. 3, or be distributed among various electronic devices, wherein each device might contain one or more processes or routines that together constitute a server application. Where appropriate, server should be construed, in addition or in lieu of the discussion above, to be a device upon which one or more server processes execute, for example, server 200 or client computer 300.

Overview

The object model in accordance with the present invention provides specific objects that can be used to model schemas for applications such as database or enterprise applications. The schemas may also be system independent, such as the structure of a web form, a search UI (user interface), or tagging screen. In fact, the same “schema” may exist in multiple systems or instantiations.

Large organizations, both private and public, often have many different enterprise applications. These may include content management systems (CMS), customer relationship management systems (CRM), or proprietary systems developed in house. The value of these applications is their ability to collect, store, manage, and retrieve information. Even when these applications have been designed and implemented well most organizations are finding that in order to truly take advantage of the information already collected, they need to be able to share the information between systems. For example, the information in a CRM system is typically far more valuable when it can be used in conjunction with a CMS. In this situation a company can better take advantage of its information assets by using the material in the CMS by targeting appropriate information to individual customers.

This situation can be clearly seen in the example of a merger between two companies or government agencies. In this typical situation, information might only be valuable when it is consolidated or understood as a whole.

The general problem at hand is the problem of sharing, managing, and using data from disparate systems. This problem may take many different forms, but in each incarnation the issues of data compatibility, maintenance of data standards, impact analysis, and propagation of schema standards are usually implicated.

An object model in accordance with the present invention provides a set of tools, which allows users to:

Define re-usable data types (Element objects) so they can be used across many different systems.

Create collections of these elements, (Content Class objects), which describe different structural or logical concepts; systems, forms, or reports, for example.

Create and model simple to sophisticated vocabulary or thesaurus structures (Vocabulary, Term, Term Relationship objects).

Create different versions of these schemas which maintain the data description but which also allow for idiosyncratic difference between systems. This allows for representing labels or values differently depending the context, whether that context be a language or a computer system. (Class Element, Vocabulary View objects).

Create extensive and robust localization of element values and vocabulary terms (Element Value, Term Value objects).

Determine the impact to different systems or users of any change to the schemas

Customize the change management process per object (Contract Object).

Propagate the schemas to target systems.

By providing functionality that supports the items listed above, the object model in accordance with the present invention provides a solution to the problem faced by many large organizations. The object model provides flexibility that is apparent in both the schema modeling the object model supports and the ability of the object model that allows for associating context specific information to schema objects.

In particular, Table 2 below describes an object model that provides the following objects that allow for the associating of context specific information to other schema objects:

TABLE 2

| Object | Purpose |
|---|---|
| Class | This in conjunction with the Content Class Object |
| Element | and the Element Object provides a unique solution |
| Object | to the problem of mitigating the inevitable |
| | idiosyncrasies which occur between systems even |
| | when they are defining identical concepts. |
| Element | This object provides the flexibility necessary to |
| Value | represent element names and descriptions in |
| Object | multiple languages. |
| Term | This object provides the flexibility necessary to |
| Value | represent vocabulary term names and descriptions in |
| Object | multiple languages. |
| Term | This object supports the ability to define different |
| Relationship | types of relationships between terms. These |
| Type | relationships can have different business rules |
| Object | associated with them. They are also used to create |
| | different views of vocabularies. |
| Vocabulary | This object allows users to create views of subsets of |
| View | a vocabulary. |
| Object | |

The object model as a whole provides for the modeling of a centralized collection of schema objects, which can allow organizations to more effectively describe their electronic information. The five objects listed above provide the ability to specifically associate context dependent information to the schema definitions. This allows organizations to more effectively share and re-use schema objects across multiple systems

Object Relationship Notation

Table 3 describes common types of relationships between objects:

TABLE 3

| | | |
|---|---|---|
| (1-1) | One-to-One | The primary object may have only one relationship to a subordinate object of |
| | | that type. The subordinate object is “owned by” the parent object and can be |
| | | related to only by that one parent object. |
| | | Example: An aircraft may have only one “current location” |
| (1-M) | One-to-Many | The primary object may have multiple relationships with subordinate objects |
| | | of that type. The subordinate objects are “owned” exclusively by the primary |
| | | object. |
| | | Classic Example: A Purchase Order may have multiple line items. A line item |
| | | is typically related to only one PO. |
| (M-1) | Many to One | The primary object may have only one relationship to a subordinate object of |
| | | that type. However, unlike 1-1, multiple primary objects may relate to the |
| | | same subordinate object. |
| | | Example: A Research Project may have only one “Lead Researcher” however |
| | | multiple Research Projects may have the same “Lead Researcher”. |
| (M-M) | Many-to-Many | The primary object may have multiple relationships with subordinate objects |
| | | of that type. Subordinate objects may have similar relationships with multiple |
| | | primary objects. Classic Example: Authors may have multiple books. Books |
| | | may have multiple authors. |
| ? | Optional | A relationship of this type is optional |
| * | Required | A relationship of this type is required |

Schema Object Model

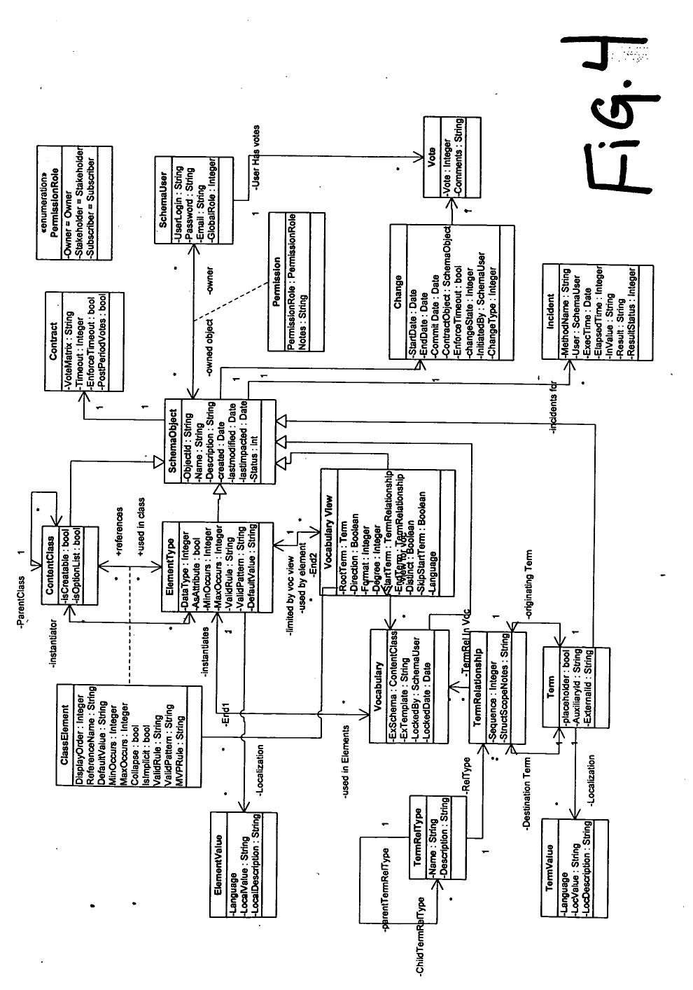

FIG. 4 is a schematic diagram of an example Schema Server Object Model, in accordance with the present invention. Schema Object is a super-class of five major Schema Server conceptual objects: Content Class, ElementType, Vocabulary, Term and Vocabulary View. All of these objects have their own specific semantics, but share the common characteristics of being Schema Objects:

They have a direct impact on the substance of an abstract Schema Definition;

They can be owned;

They are involved in impact analysis, both as starting points of impacts and as impacted objects;

Their workflow processes can be tracked and logged.

The properties of this object support the administrative tasks of modeling, managing and propagating schemas. Table 4 lists example properties of the object model:

TABLE 4

| Name | DataType | Description |
|---|---|---|
| ObjectId | GUID | A universal, lifetime identifier for the object. Having an abstract, |
| | | global identifier provides both practical and conceptual advantages, |
| | | including the transportability of definitions across repositories, and the |
| | | reduction of namespace issues associated with name-based identifiers. |
| Name | String | The object name is used for convenient identification of the object and |
| | | established the default name of the object for projection into client |
| | | systems. |
| | | Some SchemaObject types (e.g. ElementType) enforce name |
| | | uniqueness while others (Term) do not. |
| Description | String | The description property provides for a more extensive, human- |
| | | readable semantic definition of the schema object primarily intended |
| | | for managers of the schema definitions. |
| | | Note: Element Typeand Term SchemaObjects include separate |
| | | language-specific features for storing human-readable descriptions of |
| | | those objects for use by end-users and for projection into end-user user |
| | | interfaces and documentation. |
| Created | Date | The Date/Time that the object was created |
| LastModified | Date | The Date/Time that the object was last modified (added/updated) |
| LastImpacted | Date | The Date/Time that the object was last impacted either directly or by |
| | | “downstream” objects being modified. This is updated when a change |
| | | is “approved” in the system, not when it is initially posted. |
| Status | Int | The current state of the object, specifically either Approved or in some |
| | | pending state of add, update or delete. |
| | | See WorkState enumeration for details of each state. |

Additionally Schema Objects can be associated with permissions, contracts, changes, and incidents. For example, a Schema Object may have zero-or-more permissions against it. (See “Permission” object described below.) This is a typically a navigable relationship. The list of permissions against any given Schema Object may be extracted from the system.

A Schema Object may have one optional Contract. The Contract specifies certain parameters for the Change Management process that is initiated when this Schema Object is involved in a data modifying operation (Add, Update, Delete, Move). If a change is made to a Schema Object that does not have a contract directly associated with it, “Contract Negotiation” logic is invoked to identify the most relevant contract to be used according to special impact analysis logic specified elsewhere. (See “Contract” object below.)

A Schema Object may have one optional Change associated with it at any time. The associated Change object represents the current or most recent change transaction against the associated Schema Object and tracks the change state information. The Change object may also store certain Contract conditions as of the initiation of the change process to ensure that subsequent changes to the Contract do not undesirably impact the Change rules.

Incident objects typically track every API transaction against a Schema Object. A Schema Object may have zero-or-more incidents associated with it. Incidents can be purged or rolled out of the online system to reduce system bulk if necessary. The system administrator may optionally maintain a complete log of all incidents for all schema objects.

Content Class

Content Classes can be used to abstractly represent virtually any aggregate structure definition. Content Class objects are a sub-class of Schema Object. As such, all properties and relationships of Schema Object typically apply to Content Class. Content Classes are, simply, lists of Element Type references. Each reference to an externally defined Element Type definition usually includes optional overriding properties that contextualize the reference in such a way as to refine, restrict or recast without violating the underlying definition or compromise mapability of the Schema Object.

Optionally, a Content Class may be defined as “creatable” which corresponds to the inverse of the conventional Object Oriented concept of “abstract,” which indicates whether the structure definition is (or is not) intended for instantiation, or intended as a conceptual building block for other inherited or aggregating complex structures (such as child content classes or other aggregate content classes). Additionally, a Content Class may be defined as an “option list” indicating that of the referenced Element Types, only one may appear in any instantiation.

Content Class objects are used to define abstract data structure definitions as aggregations of Element Type references. These may be used to describe actual database schemas, Web Forms, Search Interfaces, other data definitions, and the like.

Content Class objects are also subject to class inheritance. For example, each Content class other than the root class has one parent. Each content class inherits the elements associated its ancestors. To describe non-essential idiosyncrasies of elements some of the properties of an element can be overridden. (See the Class Element object below).

The grant of “owner” permission to a class implicitly grants “owner” permission to its sub-classes. This permission grants the ability to add, update and delete any of these Content Classes (within the constraints of change control collaboration) and grants the permission to grant permissions on these Schema Object to other users.

Impact analysis evaluation flows from a class toward its descendent classes (leaf nodes). If a change is made to an Element Type referenced by a Class C1, the descendent classes of C1 can be considered impacted. Any users with permissions to any descendent classes can be considered impacted and receive votes on the Change process.

Contract negotiation logic typically flows from an impacted Content Class toward the root of the Content Class tree. If, within an individual impact analysis graph, multiple Content Classes are individually impacted by outside Element Type references, the common parent of directly impacted Content Classes is assessed. The contract in force is evaluated as the contract associated with the class closest to the common parent Content Class.

Example properties of Content Class objects are shown in Table 5:

TABLE 5

| | | |
|---|---|---|
| isCreatable | Bool | True - The Content Class can be instantiated in some target or |
| | | client system. |
| | | False - The Content Class is not intended for instantiation. This is |
| | | commonly called an “abstract class”. The class is intended as a |
| | | management structure to provide for inheritance or management |
| | | structure. |
| isOptionList | Bool | True - The Content Class represents a set of Element Types, only |
| | | one of which should optionally occur within any use context. |
| | | Content Classes with the “isOptionList” property set to True are |
| | | typically used as components within other class structures and are |
| | | rarely stand-alone. (Example: Class BusinessId is an OptionList |
| | | and contains elements FederalTaxId and SocialSecurityNumber. |
| | | This indicates one or the other but not both elements may appear.) |
| | | False - A standard content class, all elements appear (typically in |
| | | specified sequence), with cardinality rules specified individually |
| | | for each Element Type. |

Content Classes may have one or more elements associated with them. Elements can be either directly associated with the content class, or inherited from parent content classes. Each relationship between a Content Class and Element Type can be qualified by a Class Element object that provides contextual properties that either override or otherwise alter the interpretation or rules for use of the Element Type definition.

In accordance with the present invention, a Schema Server typically does not support explicit embedding definitions of sub-elements within the scope of the encompassing structure (in this case Content Class). The sub-element definitions are typically drawn from a globally visible set of Element Type definitions. The value of this approach for applications is to encourage global visibility and maximize reuse of definitions, while providing for local contextualization. Local scope definition of Elements (or Attributes) typically trades off manageability for convenience.

All Content Classes other than the built-in root class typically have one parent Content Class. This relationship defines the class inheritance mechanism. Consequently all Content Classes can be organized as a single-inheritance tree.

Element Type

Element Type objects define reusable data component definitions that control or represent corresponding structures in one or more client systems and, as such, are a central part of schema modeling. Element Type objects are flexible objects that represent a set of concepts that are often considered discrete structures by some models (e.g., both XML Elements and Attributes can be modeled as Element Types). Table 6 defines mapping concepts within typical disciplines or models:

TABLE 6

| Model or Discipline | Maps to concept |
|---|---|
| XML | SimpleType, Element, Attribute |
| Relational | Column |
| General DB | Field |
| Object Modeling | Property |
| Metadata | Tag |

The value of the model and its emphasis on collaboration, mapping and management typically depends explicitly on the generality of the modeling concepts such as Element Type. This generality allows the most liberal technical and conceptual mapping across disparate models.

Element Types commonly define simple, “scalar” data type definitions such as “Title”, “Author”, “PurchaseQuantity”, “SKU”, “DueDate” or “FlowRate” that are expressible as single values of common data types such as integer, string, date-time or floating-point number.

Some Element Types represent a Content Class for purposes of composition within another Content Class. Element Types specify a variety of properties and relationships that Content Classes do not such as cardinality rules, Display Labels etc. Use of “class-Type” Element Types generally simplifies the modeling of complex Content Class structures.

Vocabulary-type Element Types model, in an implementation-independent way, a wide range of requirements where an Element Type may only contain a value from a well defined and intentionally controlled list of values.

In some cases, it may be desirable to define Element Types that are abstracted prototypes for other more concrete Element Type definitions. For example an Element Type may be called “URLType” and define the basic data, semantic and syntactic rules for representation of an URL including the regular expression rules for an W3C URL string. Other Element Types (e.g. “ImageURL”) may refer to “URLType” as the basis for their definition rather than the primitive data type “string.” This facilitates centralized definition of certain data rules and definitions and enhances understandability and manageability.

Table 7 describes various properties that are associated with Element Type:

TABLE 7

| Name | DataType | Description |
|---|---|---|
| DataType | Integer | Integer which corresponds to the ElementDataType Enumeration |
| | | described below |
| AsAttribute | Bool | This property is used to denote whether or not an element should |
| | | be represented as an attribute in an XML schema when the content |
| | | class it is used in is published. |
| MinOccurs | Integer | Used to describe the minimum number of times an element can be |
| | | instantiated in target system. This can be overridden by the class |
| | | element |
| MaxOccurs | Integer | Used to describe the maximum number of times an element can be |
| | | instantiated in target system. This can be overridden by the class |
| | | element |
| ValidRule | String | Valid Rule and Valid Pattern provide a generalized |
| ValidPattern | String | specification mechanism that can be standardized within any |
| | | organization to store and distribute validation rule |
| | | specifications. |
| | | The Valid Rule/Valid Pattern field pair may be used to store |
| | | organizationally standardized cross-platform validation |
| | | specifications or platform-specific specifications, in cases |
| | | where the specific technology of the primary consuming |
| | | systems of the Element definition are known. See example |
| | | below. |
| DefaultValue | String | The default value for the element. Default value is an un- |
| | | validated string and it is the responsibility of the schema |
| | | editor to enter a valid value. |
| | | Default value is valid for only the “simple scalar” data types |
| | | and is not displayed for Class-type or Vocabulary-type |
| | | Element definitions. |

Examples of valid rules and patterns are shown in Table 8:

TABLE 8

| Valid Rule String | Valid Pattern String |
|---|---|
| REGEX | “href\\s*=\\s*(?:\“(?<1>[\hat{ }\”]*)\”\|(?<1>\\S+))”, |
| | “i” |
| REGEX | “\d{2}−\d{5}” |
| NUMRANGE | (1-2000) |
| DATERANGE | (<TODAY> − 24, <TODAY> + 7) |
| VALIDDOMAINUSER | Group(“Marketing”) |

Object definitions in this model are used to associate concepts with Element Types. Conventional modeling systems that aspire to provide an overarching modeling system such as UML include a similar concept, called “Property.” Also Data Dictionaries or Repositories also frequently provide for a common catalog of data definitions.

In accordance with the present invention, use of a globally unique identifier as the primary identifier of Element Types provides for bridging namespaces more effectively. Use of globally unique identifiers enables effective element re-use across systems as well as supporting the notion of class elements. Provision of unique human readable names allows decision makers to identify and discuss objects of interest within the context of collaboration. Combining Element and Attribute definitions (in the case of modeling XML structures) helps to clarify the actual unity of the conceptual space and simplifies management and mapping into other data modeling domains (e.g., relational domains). Defining default cardinality properties (minoccurs, maxoccurs) in the Element Type definition provides (non-binding) guidelines for usage.

Generalized Valid Rule/Valid Pattern mechanism for defining data validation mechanism provides for both a centralized definition of these rules, open extensibility while not binding to a particular technical implementation of these rules. Identification of a validating set of values (Vocabulary-type Element Type) is done by reference to an external definition and not embedded within the Element Type definition itself. This provides for multiple Element Types sharing the same or variant views of the same domain (e.g., Geography).

Element Types include not only machine-readable definitions of data type but human-readable definitions, for management and for-multi-lingual end-user representation (labels and descriptions), in forms and reports. Centralized management of end-user human readable labels and definitions enhances consistent use and understandability of shared information. Manageability through a common namespace, searchability, permissions, bi-directionally navigable relationships and intrinsic change management substantially enhance lifecycle usefulness and reusability of Element Type definitions over conventional approaches.

An Element Type can optionally have a one-to-one (1-1) relationship with a Vocabulary. If an Element Type is of type Vocabulary, it may be associated with one Vocabulary. Vocabularies provide a list of allowed values that define the scope of legal values to be assigned to the Element.

Association of the Vocabulary with the Element Type by reference allows the same Vocabulary Domain to be utilized by multiple Element Types for different purposes (See Vocabulary View below). Element Types define not only a data definition but also can define a semantic use purpose. If the Vocabulary has one or more vocabulary views associated with it, then a vocabulary view may also be associated with the element.

The Vocabulary View mechanism provides a useful mechanism to form a subset of a larger vocabulary for specialized purposes. For example, a list of product categories from a products vocabulary including 5000 separate terms is required for the Element Type “ProductCategory.” The Vocabulary “Products” Element Type is specified and the Vocabulary View “AllProductCategories” Element Type is further specified to restrict the values to the desired subset for this application.

Element Types may be referenced by zero-or-more Content Classes. In a well-designed system many Element Types can be shared by many Content Classes. This sharing of Element Types encourages data homogeneity, data sharing, and data re-use across systems and is an important part of centralizing the schema modeling process as this is where the elements can be “re-used.”

Conventional relational database systems can reference Column definitions from a common system table but the Element Types cannot be referenced by multiple tables. Other Relational systems (PICK) could allow use of a common set of data definitions but typically are limited to non-data defining structures (called symbolics).

In accordance with the present invention, use of a common Element Type definition by multiple systems and structures, is not typically supported by Relational systems (and is poorly supported by UML and XML definitions), particularly with regards to lack of bidirectional navigability and manageability. Impact analysis is not easily accomplished. Embedding of Element, Attribute or property definitions inhibits reuse. The example object model emphasizes and enforces the mechanism of central definition with unique identifiers and bidirectional relationships to provide an optimal condition for Element Type reuse. All relationships to Content Classes can be qualified by Class Element objects to condition and qualify the application of the Element Type.

Vocabularies

Vocabularies provide a flexible mechanism for describing sets of approved tagging values for Elements. Vocabularies can be, for example, simple lists of terms or complex hierarchies, including: Geographical terms (Regions, Countries, States, Cities . . . ), Product Hierarchies, Site navigation hierarchies, Marketing Segmentation taxonomies, Scientific Taxonomies. Vocabularies provide a manageable and implementation independent mechanism for describing a wide variety of finite, controlled and enumerated domain structures that occur frequently in real data management applications.

In conventional Relational systems, the common correlative concept is “lookup table” and Referential Integrity or index. Many relational database applications include tables that exist primarily to constrain the values of certain columns in primary data tables to a set of approved values, be they “States”, “Product Id” or “Customer Category.” In more complex situations, the set of values may be further organized into hierarchical or poly-hierarchical structures. XML Schema includes only the simple concept of “enumeration” to address restriction of an element or attribute to a finite set of values. Also, Thesaurus-structured Vocabularies are an established construct with flexible application. Accordingly, there is a need to provides support for the conventional structures.

In accordance with the present invention, manageability of structures can be provided by incorporation of granular, inherited permission management, impact analysis, contracts and change management to vocabularies. This functionality can provide substantial advantages for large organizations developing and maintaining critical definitions.

Intrinsic support for localization can simplify administration and substantially increase the power and usability of vocabularies to power cross-language search and retrieval. Extensible Term Relationship Types can be implemented by taxonomists to design arbitrarily specific and meaningful relationship types that can subsequently be used to analyze, navigate and “subset” vocabularies. Vocabulary views provide a parametrically defined, managed and controlled subset definition mechanism in combination with extensible term relationship types to support the management of common vocabularies that are useful across complex organizations.

Example Vocabulary Properties are shown in Table 9:

TABLE 9

| Name | DataType | Description |
|---|---|---|
| ExtensionSchema | Content | Extension Schema provides |
| | Class | the definition for structured scope |
| | | nodes, called here “Extension |
| | | data”. This allows controlled, |
| | | extensible structured data |
| | | to be attached to all Term |
| | | Relationships. |
| ExtensionTemplate | String | The XSLT template used by |
| | | default to display |
| | | extension data. |
| LockedBy | SchemaUser | Who has locked the vocabulary |
| | | for bulk updating |
| LockedDate | Date | When was the vocabulary locked |
| | | for bulk updating. |

Vocabulary views (having a 1-to-M relationship) allow users flexibility to present different views or subsets of vocabularies to meet the needs of different contexts. Each vocabulary may have multiple views associated with it. A vocabulary is a collection of relationships between terms. The term relationships themselves actually reference the terms associated with the vocabulary.

Terms

Terms are the conceptual nodes, represented by individual words or phrases used in vocabularies. In a Schema Server they are much more than just a string. Terms are identified by a lifetime GUID, and include extended internal descriptions and localized translations of term values and descriptions. When used in a vocabulary terms are “related” to each other via “term relationships.” By following these relationships there is a path up to the Root term of the vocabulary. Terms can also be used in multiple vocabularies.

The Object Model Term typically inherits all properties of Schema Object, including global Id, Name, Description and workflow properties and change management relationships. Typical properties of the Object Model Term are shown in Table 10:

TABLE 10

| Name | DataType | Description |
|---|---|---|
| PlaceHolder | Bool | A Placeholder Term is one that serves a structural purpose |
| | | as a parent of sub-terms in a hierarchical vocabulary but is |
| | | not itself intended as a tagging term. |
| AuxilaryID | String | If SchemaServer provides Terms for a subscribing |
| | | technology that has it's own internal identifier system for |
| | | Terms other than the Name of the term, Auxiliary ID may |
| | | be used to store this secondary identifier. |
| ExternalID | String | If SchemaServer imports a Vocabulary from an external |
| | | authority and that Vocabulary scheme includes an identifier |
| | | scheme other than the Name, That External Identifier |
| | | should be stored in External ID. This permits repeated re- |
| | | synchronizations with the authority list while maintaining the |
| | | identity of the Terms being managed so that an Update to |
| | | an existing term may be distinguished from the addition of a |
| | | new term. |

A term value optionally can have a one-to-many (1-M) relationship. This relationship is used for localization of terms. Not all terms need to have a Term Value (or localized value) but this relationship does allow terms to have different values and descriptions in the context of different languages.

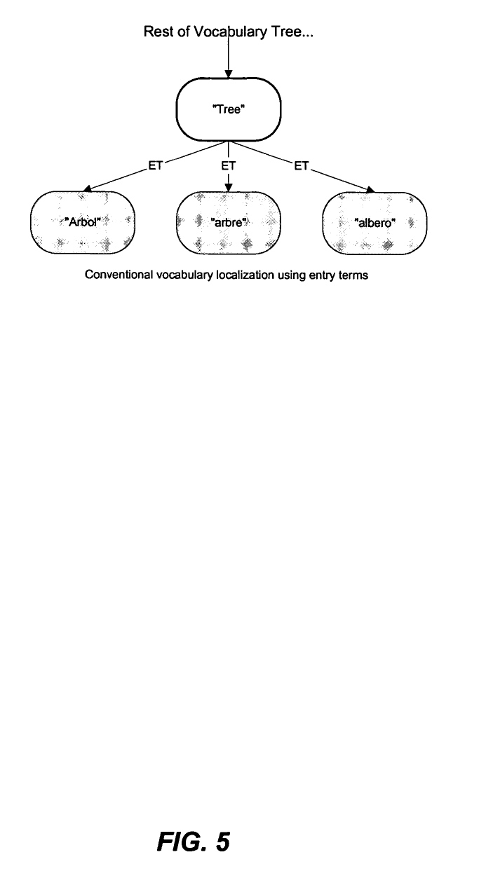

A conventional method for localizing terms in controlled vocabularies is to represent the localized values as separate terms associated to the “preferred term” with a special type of relationship (frequently called an “entry term” relationship). FIG. 5 is a schematic diagram showing a conventional vocabulary localization using entry terms. In accordance with the present invention, this conventional approach is supported but is supplemented with an intrinsic localization mechanism.

Term localization is incorporated as an intrinsic property set of the Term object. Management is simplified as the term localizations are carried with the Term wherever it is used (in different Vocabularies). Workflow processes are streamlined as modifications to localizations are managed as properties changes to the term. Management of localization processes is enhanced as it is now relatively easy to identify terms within a vocabulary that perhaps have (or have not been) localized in a particular language. Use of localized terms is enhanced as it is now relatively easy to extract a given vocabulary in any language into which it has been localized.

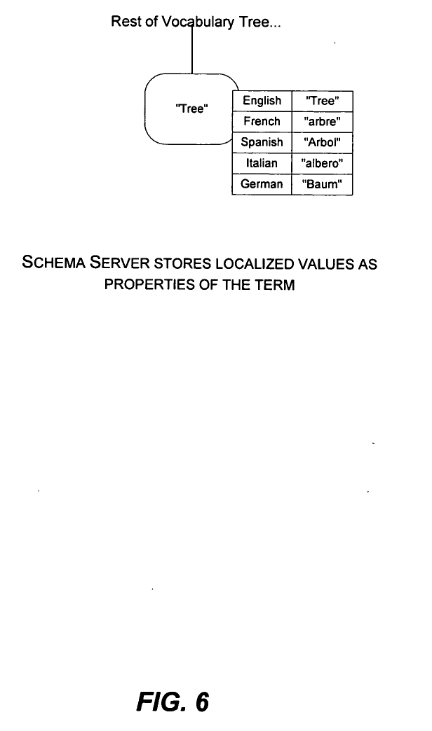

FIG. 6 is a schematic diagram showing an intrinsic vocabulary localization mechanism using entry terms, in accordance with the present invention. In the figure, the localized values are stored as properties of the Term.

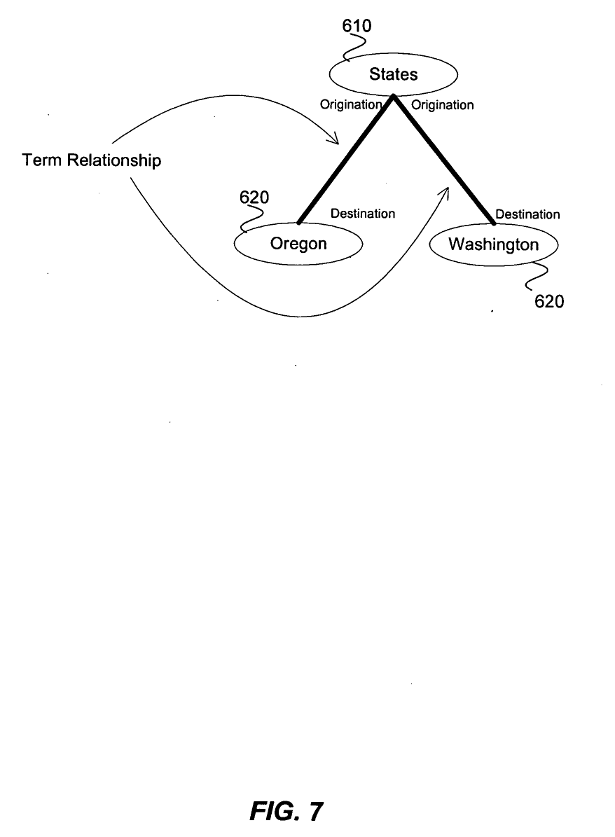

FIG. 7 is a schematic diagram showing a term relationship of one to many, in accordance with the present invention. As shown in the figure, each Term Relationship has an Origination 610 and a Destination 620 (parent-child) term associated with it. In the diagram below the bold lines are the actual term relationship objects. Thus, “Oregon” and “Washington” are the “Destination” 620 terms and “States” is the “Origination” 610 term.

Vocabulary View

Vocabulary Views help to reconcile the need for centralized management of enterprise Vocabularies with the need of individual subscribers to consume subsets of sometimes overwhelmingly large sets of terms. Table 10 shows example properties of Vocabulary Views:

TABLE 10

| Name | DataType | Description |
|---|---|---|
| StartTerm | Term | The starting term of this particular |
| | | Vocabulary View |
| Direction | Integer | The search direction for the View. |
| | | This is almost always “Search Down” from |
| | | the root or Start Term down the tree. |
| | | Searches may be directed up from the target |
| | | term to source terms. Searches in |
| | | the “up” direction are most useful in cases of |
| | | inverting related term relationships |
| Format | Integer | Vocabulary views may be formatted as a |
| | | flat list of terms or as a hierarchy, retaining |
| | | the structural relationships. |
| StartTermRel | TermRel | Term Relationships to be included in the |
| | | result set. The terms related via this term |
| | | relationship type or any descendant type in |
| | | the termreltypetree will be included in the |
| | | result set. (See endTermRelType below) |
| EndTermRel | TermRel | Any TermRelTypes below this termreltype |
| | | will not be included in the result set. This |
| | | defines the lower bound of term relationship |
| | | types of interest. |
| SkipStartTerm | Boolean | Should the start term be included |
| | | in the result set |
| Distinct | Boolean | Should duplicate appearances of terms be |
| | | included in the result set. If polyhierarchical |
| | | vocabularies are flattened, duplicate |
| | | terms may result. |
| Degree | Integer | How many generations of descendent terms |
| | | should be included in the result set. |

Vocabulary Views provide a unique, manageable mechanism that allows for large, complex, aggregate or highly multi-constituent vocabularies in a collaborative environment. Vocabulary Views are defined parametrically and use only pre-defined relationships as the mechanism for sub-setting views. From the standpoint of manageability through impact analysis, this approach is markedly superior to a procedural or even non-procedural query-based method based on term properties.

Vocabulary Views as described herein have the following advantages:

Easy for non-programmers to define and maintain;

Are easily evaluated and compared for changes by stakeholders;

Impact analysis logic can determine whether and which vocabulary views are impacted by vocabulary (term or term relationship) changes;

Vocabulary Views are managed as SchemaObjects with the conferred values (Permission control, upstream and downstream impacts, voting, replication);

Easily facilitates management of poly-hierarchical (multi-view) vocabularies with distributed permission control; and

Facilitates securing of views of Vocabularies for high-security applications.

A Vocabulary View is provided using a many-to-one relationship (M-1). Each Vocabulary view typically must refer to no more than one Vocabulary. Vocabulary views allow users flexibility in the way they view, present, or “subset” vocabularies.

Vocabulary views may be associated with an element which is of type Vocabulary in a one-to-many (1-M) relationship. If the vocabulary associated to the element has Vocabulary Views associated with it then a vocabulary view may be associated with the element as well. By allowing this connection users of the system are able to manage a vocabulary as a large monolithic object (for example a complete product vocabulary) but present only the relevant parts to different users. Thus, a product vocabulary may have 5000 terms in it, but a list of only product family names could be delivered to the Marketing department, while the list of all products and versions of products could be delivered to the technical support team.

Vocabulary views may be referenced by the class element object using a one-to-many (1-M) relationship. This allows for changing the view of a vocabulary in the context of a content class.

Class Element

Class Elements are objects used to describe and modify the usage of Element Types in the context of a Content Class. Class elements provide an opportunity to override some elements properties in a content class as well as providing for the ability to define further validation and display rules for an element in the context of a Content Class. Table 11 shows example properties of Class Elements:

TABLE 11

| Name | DataType | Description |
|---|---|---|
| DisplayOrder | Integer | This property is used by target systems and describes the |
| | | order in which the element should be displayed |
| Referencename | String | The local name of the element in the context of this |
| | | content class |
| DefaultValue | String | The default value for the element. Default value is |
| | | an un-validated string and it is the responsibility of |
| | | the schema editor to enter a valid value. |
| | | Default value is valid for only the “simple scalar” |
| | | data types and is not displayed for Class-type or |
| | | Vocabulary-type Element definitions. |
| MinOccurs | Integer | Used to describe the minimum number of times an |
| | | element can be instantiated in target system. This can be |
| | | overridden by the class element |
| MaxOccurs | Integer | Used to describe the maximum number of times an |
| | | element can be instantiated in target system. This can be |
| | | overridden by the class element |
| Collapse | Bool | If the Element Typein question is a class-type (represents |
| | | a Content Class defined in the system), This property |
| | | indicates whether the elements of that class should be |
| | | inserted into the class without any enclosing structure. |
| | | This property is primarily intended as a formatting guide |
| | | for schemas structured in XML Schema format. This |
| | | resolves to the equivalent of an Attribute Group, Element |
| | | Group, or embedded unnamed sequence or choice |
| | | structure. |
| IsImplicit | Bool | If the Element Typein question is not a class-type |
| | | element IsImplicit specifies that the element defines the |
| | | unnamed implicit data definition for the body of the |
| | | encompassing content class. This is intended as a |
| | | formatting guide for XML schema where an Element |
| | | definition can contain content directly in the body of the |
| | | element and additionally have attributes. Only one |
| | | Element Typemay have the IsImplicit element set for a |
| | | given Content Class. This also applies to inherited |
| | | Elements. If an Element Typeinherits an implicit element |
| | | from an ancestor Content Class, it may not specify a |
| | | different or additional implicit element. |
| ValidRule | String | Valid Rule and Valid Pattern provide a generalized |
| ValidPattern | String | specification mechanism that can be standardized |
| | | within any organization to store and distribute |
| | | validation rule specifications. |
| | | The Valid Rule/Valid Pattern field pair may be used |
| | | to store organizationally standardized cross-platform |
| | | validation specifications or platform-specific |
| | | specifications, in cases where the specific |
| | | technology of the primary consuming systems of the |
| | | Element definition are known. See example below. |
| MVPRule | String | Reference to the rule used by the Meta Data Validation |
| | | tool to validate element values. |
| | | MVPRules specify runtime schema modification rules |
| | | that depend on the data values of other elements. |
| Vocabulary View | | Handled in the Valid Rule field. |
| | | While the actual vocabulary cannot be modified at certain |
| | | times, the vocabulary view may usually be modified. |

Unlike conventional structures described in, for example, XML, the example Object Model explicitly does not support embedding definitions of sub-elements within the scope of the encompassing structure (in this case Content Class). All sub-element definitions are typically drawn from a globally visible set of Element Typedefinitions. The value of this approach for this application is to encourage global visibility and maximize reuse of definitions, while providing for local contextualization. Local scope definition of Elements (or Attributes) trades off manageability for convenience.

Other advantages include bi-directional navigation of relationships, which facilitates impact analysis and generation of mapping tables. Structured overrides of Element Type properties are facilitated while retaining the underlying core data definitions in Element Type. MVP Rules allow non-procedural encoding of interdependent data validation rules at the class level in a manageable and impact analyzable format. Definition of “implicit” class elements (XML Complex Type/Simple Content) as an advisory property allows greater clarity and generality of structure definitions across models and implementation architectures.

Class Element objects are annotational objects that are associated with the relationships that indicate the association of an Element Type with a Content Class. (See Content Class, above, and Element Type, also above).

Term Relationship

The Term Relationship object relates two existing Term objects. A collection of these relations (links) between terms constitutes a vocabulary. Each link has an origination term and a destination term. The destination terms is generally treated as a “child” of the origination term. Depending on the TermRelType of the Term Relationship different business rules apply.

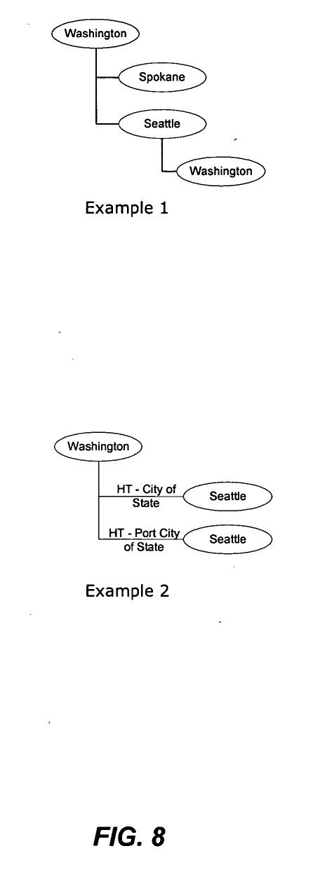

FIG. 8 is a schematic diagram of two example structures that illustrate term relationships. In Example 2 Seattle is the Destination term and Washington is the Origination Term.

When building Vocabularies, Terms can never be descendents of themselves. Thus, Example 1 shows an invalid tree structure because the term “Washington” is a descendant of itself.

Also, there should be no duplicate relationships between identical terms. There can be multiple relationships between terms, but each relationship typically must be different. In Example 2 there are two relationships between “Washington” and “Seattle”. This is a valid construct because there are different relationship types used.

(See TermRelTypes below for more information.)

Table 12 shows example properties of the Term Relationship object:

TABLE 12

| Name | DataType | Description |
|---|---|---|
| Sequence | Integer | Order of appearance of term |
| | | relative to it's immediate |
| | | parent term. |
| StructuredScopeNotes | String | A place to provide additional |
| | | information about the particular |
| | | relationship between the two terms. |
| | | See Extension Schema (Error! |
| | | Reference source not found.) |
| OriginationTerm | String | ObjectId of the Origination Term |
| DestinationTerm | String | ObjectId of the Destination Term |
| VocabularyID | String | ObjectId of the Origination Term |
| | | Vocabulary |
| DestinationVocabularyID | String | ObjectId of the Destination Term |
| | | Vocabualry. This must be the same |
| | | as the originating VocabularyId |
| | | except when the Term Relationship |
| | | is an RT (Related Term) |
| | | type relationship. |

Each Term Relationship is associated with a vocabulary in a one-to-one relationship. It is possible, when the Term Relationship is of type “Related”, that the destination term relationship can refer to a term in a second vocabulary.

Each Term Relationship is associated with a Term Relationship Type (TermRelType). Each Term Relationship Type can have different business rules associated with it, which describe how the Term Relationship can be used in the Vocabulary.

Each term relationship typically has a required one to one relationship with both an Origination Term and a Destination Term.

Term Value

Term Value is an object that allows for the “localization” of vocabulary terms. Each Term may have one term value per language. The list of languages can be managed as one of the enumerated lists mentioned below in Table 13. When using this feature, the term “Name” and “description” are typically localized.

Table 13 shows example properties of the Term Relationship object:

TABLE 13

| Name | DataType | Description |
|---|---|---|
| Language | Integer | Refers to the Local ID (LCID) of the |
| | | language. The list of LCIDs is kept as an |
| | | enumerated list. |
| LocValue | String | Localized value of the term name |
| LocDescription | String | Localized description of the term description |

A conventional method for localizing terms in controlled vocabularies is to represent the localized values as separate terms associated to the “preferred term” with a special type of relationship (frequently called an “entry term” relationship). In accordance with the present invention, this conventional approach is supported but is supplemented with an intrinsic localization mechanism.

Term localization can be incorporated as an intrinsic property set of the Term object. Management is thereby simplified as the term localizations are carried with the Term wherever it is used (e.g., in different Vocabularies). Workflow processes are streamlined as modifications to localizations are managed as properties changes to the term. Management of localization processes is enhanced as it is now relatively easy to identify terms within a vocabulary that have and/or have not been localized in a particular language. Use of localized terms is enhanced as it is relatively easy to extract a given vocabulary in any language into which it has been localized.

The Term Value is used when a term is “Localized”. Thus, each Term may have multiple values where each value is identified with a particular, defined, context. This context may be a language, but it could also be per system, whatever the user deems necessary. The list of “Contexts” is described in the “Languages” enumerated list. The Term Value is typically used in a one-to-one (1-1) relationship.

TermRelType

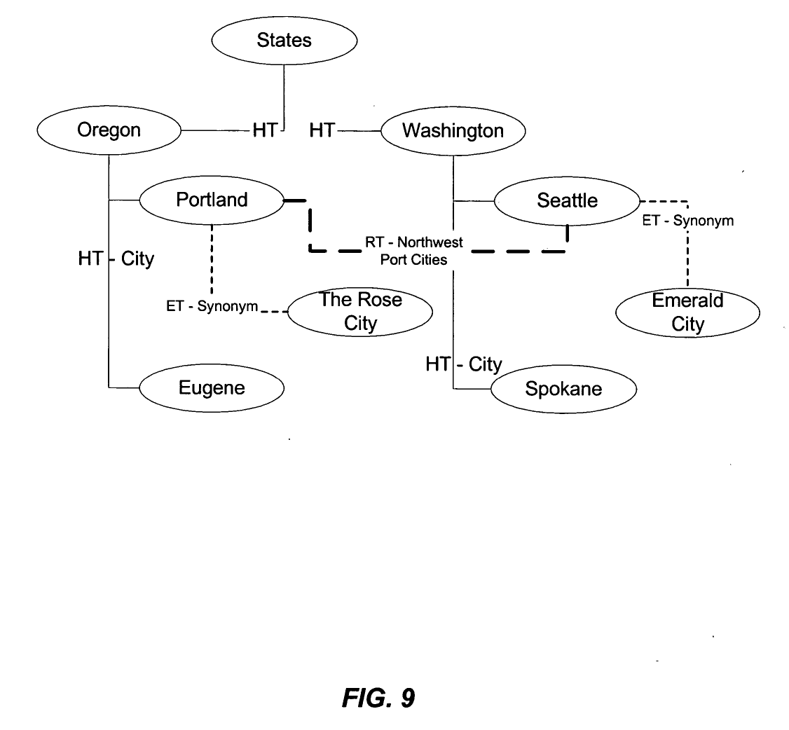

The TermRelType object describes the Term Relationship object. There are typically three classes of Term Relationship Types and each has a different set of business rules associated with it. FIG. 9 is a schematic diagram three classes of Term Relationship Types, in accordance with the present invention.

As shown by the figure, Hierarchical Term Relationships (HT) are the primary relationship type used to construct most Vocabulary relationships. These describe a “parent-child” relationship and are often referred to as “Broader Term-Narrower Term” relationships.

Entry Term Relationships (ET) are often referred to as synonym relationships. The Destination term in these relationships is generally an alternate form of the Originating Term. A destination term in an ET relationship cannot then be an Originating term for other terms in a vocabulary.

Related Term Relationships (RT) are also referred to as “See Also” relationships. These generally occur between terms in HT relationships. For example an RT relationship could occur between the terms “Seattle” and “Portland”. In this case the relationship could be used to describe Port cities in the Pacific Northwest. The following example gives potential uses of these relationships. Related term-type relationships can span vocabularies. When related terms point from a term in one vocabulary to a term in another vocabulary, the target term may not be removed from it's vocabulary as long as the relationship exists

Table 14 shows example properties of the TermRelType object:

TABLE 14

| Name | DataType | Description |
|---|---|---|
| Name | String | The name of the relationship type |
| Description | String | A textual description |
| RelTypeID | Integer | A unique identifier for the reltype |

Each Term Relationship is associated with a Term Relationship Type in a one-to-many (1-M) relationship such that the appropriate business rules, display rules, and usage rules can be applied to the term relationship.

Term relationship types are organized in a simple hierarchy. The base set of Term Relationship Type classes are as describe above: HT, ET, and RT. Term relationship types inherit the business rules of their parent type class. Each Parent TermRelType is associated with child TermRelTypes in a one-to-many (1-M) relationship.

Schema User

Schema User is an object that describes users of the system. Each user has a Global Role assigned, which is either Administrator or User. Actual permissions per object are usually described in the Permission object.

Table 15 shows example properties of the Schema User object:

TABLE 15

| Name | DataType | Description |
|---|---|---|
| UserLogin | String | User's Login name |
| Password | String | User's Password |
| Email | String | User's e-mail address |
| GlobalRole | Integer | User's role (administrator or user) |
| ProxyUser | User | User who is temporarily assigned the rights and |
| | | responsibilities of this user. ProxyUsers are |
| | | granted the votes that normally are assigned to |
| | | the granting user. |

Users are assigned votes in a one-to-many (1-M) relationship. The votes are typically associated with change processes to Schema Objects. (See Votes, below.)

When a change is made to any of the Schema Objects the change control process determines if there are any users associated with the object and the permissions that Schema User has with regard to the Schema Object. The Permissions object describes the rights the individual user has with regards to the object. One of these rights may be a voting right. If the user has voting rights to the object then there is also a relationship between the Schema User and a Vote object.

Permission

Permission describes the relationship between a SchemaUser object and a Schema Object. The Permission describes the privileges a user has with regards to the management of a particular object.

Table 16 shows example properties of the Schema User object:

TABLE 16

| Name | DataType | Description |
|---|---|---|
| PermissionRole | Enumerated | This describes the type of permission |
| | List | a Schema User has with regard to the |
| | | particular Schema Object. |
| | | The enumerated list may include the |
| | | following values: |
| | | Owner - object create/update/delete rights |
| | | Stakeholder - voting rights |
| | | Subscriber - notification rights |
| Notes | String | A text field allowing used to describe the |
| | | permission |

Permission objects establish relationships between Schema Users and any sub-class of SchemaObject (Content Class, Element Type, Vocabulary, Term, Vocabulary View). In conventional file systems, the Permissions object is an implementation of a concept commonly referred to as a “access control list” (ACL). The concept is common to filing systems, directories and other network systems where security and auditability are important.

In accordance with the present invention, Permission objects simplify system management by unifying the concepts of create/update/delete access control and voting rights per the prevailing votes. The concept of Permission objects is navigable bi-directionally, allowing review and management of permissions from a user view, in addition to the view of owners of a specified object. Permissions are viewable and manageable by Administrators on a system basis, including the ability to transfer or alter permissions easily from a system console. Permissions can be proxied to other users when they are temporarily unavailable (e.g., during sickness or vacation).

Permissions inherit down vocabulary and content class trees to simplify management of relevant domains of objects. Permissions are used to control and constrain creation and management rights to enhance object reuse of Element Types and Vocabularies. Permission controls are highly granular (apply to single Schema Object definitions e.g. Term, Element Type compared to the standard methodology of managing access control on full document basis encompassing large sets of schema definitions.

Contract

Any Schema Object may have a Contract explicitly and immediately associated with it. If a Contract is not immediately associated with it, a Contract-in-force can be identified by the impact analysis logic when an impact is assessed. Each contract typically describes the parameters of the change management process.

Whenever a change is posted to the system the relevant contract is identified. The relevant contract is used to determine the voting rights of the users impacted by the change. The Contract also describes the duration of the voting period and other change control rules parameters as specified below in Table 17.

TABLE 17

| | Data | |
|---|---|---|
| Name | Type | Description |
| VoteMatrix | String | Describes the voting rights for each |
| | | permission role with regards to Add, Modify, |
| | | and Delete actions |
| TimeOut | Integer | Amount of time from the initiation of |
| | | the change until votes are tallied and the |
| | | change committed or rolled back. |
| EnforceTimeout | Boolean | If this value is true then the change cannot be |
| | | committed until the time out period is |
| | | complete. Otherwise, if consensus can |
| | | be achieved at some time before the |
| | | period ends, the change initiator may |
| | | cause the change to be committed early. |
| PostPeriodVotes | Boolean | True - Change initiator may re-initiate a tally |
| | | of votes and attempt to commit the change |
| | | after the timeout period has lapsed or an |
| | | administrator has force canceled the change. |
| | | This would allow tardy or reconsidered votes |
| | | to be retailed even after the period has |
| | | closed and the change been |
| | | flagged as “failed”. |
| | | False - The change initiator cannot cause a |
| | | change to be retallied after it has failed |
| | | through the normal scheduled process or |
| | | through Administrative intervention. |

Contracts are optionally associated with Schema Objects in a one-to-one (1-1) relationship.

In accordance with the present invention, the concept of a rigorous, computer-enforceable agreement between the provider and consumer of a resource is extended from the realm of procedural logic to the realm of structural definition. The concept is further extended from enforcing a static agreement about the definition of a resource to the idea that the process of change itself is subject to both customization by the parties and to subsequent enforcement by the agent software.

Further, the concept that customization of workflow rules are subject to inheritance allows consensus-oriented change management processes to be adjusted with greater flexibility and manageability across organizational or structural boundaries.

Change

Before a change is made to any Schema Object managed in the system, it is processed through a consensus-based change control process. During the change control process, the Change object typically maintains information about the change process. In addition to keeping track of the pending change, the Change object also typically describes the start and end date of the proposed change, the date the change was instantiated, the originator of the change, as well as the type of change proposed and the Change Contract rules that are in force. If the change is accepted then the Schema Object is modified to reflect the change.

Table 18 shows example properties of the Change object:

TABLE 18

| Name | DataType | Description |
|---|---|---|
| StartDate | Date | Date the Change was initiated |
| EndDate | Date | Date the Change period will |
| | | close and votes be tallied. |
| CommitDate | Date | Date the Change was |
| | | actually approved |
| ContractObject | SchemaObject | The object being changed |
| EnforceTimeout | Bool | See Contract |
| AllowPostPeriodVotes | Bool | See Contract |
| ChangeState | Integer | Current status of the change. |
| | | value The status is selected |
| | | from a in the ChangeState |
| | | enumerated list. (see below) |
| InitiatedBy | SchemaUser | SchemaUser who initiated |
| | | the change. |
| ChangeType | Integer | The type of change being made |
| | | (add, update, delete, move) |

The Change object is maintained in a one-to-one (1-1) relationship with a Schema Object.

The Change object is associated with Vote objects in a one-to-many (1-M) relationship. When a change is made and the object being changed or the impacted objects being changed have owners with voting rights, the change is held in a “Pending” state until the voting round is complete. The change object describes the proposed changes to the object. Upon the completion of the voting round and an approval of the change the changes are accepted and the change is completed.

Conventional workflow methodologies for document management utilize a state-transition or task-oriented model. In accordance with the present invention, the discipline and challenge of Change Management for Schema presents unique challenges that demand an intrinsically parallel consensus development approach with a fair dealer mediator (in this case Schema Server itself).

Though multiple steps may be taken in the evaluation of the appropriateness of a proposed change, ultimately, the success or failure of the change is decided based upon consensus of the impacted constituencies. Typically the consensus requires unanimity.

The defined Change management object in concert with Contracts and Votes presents a mechanism that is both simpler to understand and use and simpler to manage and configure, which help foster a collaborative culture that in fact will want to use the mechanism.

Vote

The Vote object is used to manage the voting by Schema Users on proposed changes to Schema Objects. Table 19 shows example properties of the Vote object:

TABLE 19

| | Data | |
|---|---|---|
| Name | Type | Description |
| Vote | Integer | Vote cast by a Schema User (yes, no, undecided) |
| VotingRights | Integer | Level of voting rights of the user for this change |
| | | (approve, veto, notify) |
| Comments | String | Comments made by the Schema User regarding |
| | | the vote |

A vote object is associated with a Schema User (who has a vote) in a many-to-one relationship. This is typically implemented as a bi-directionally navigable relationship.

For each Change object, there may be from one to many Schema Users voting on the change as in a one-to-many (1-M) relationship. Each Schema User can have multiple Changes to vote on.

Enumerations

A Schema Object usually has Enumeration objects, which typically include Global User Role, Permission Role, Language, Change State, Work State, and Element Data type. Global User Role is used to regulate the application of business rules. Although two levels are shown in Table 20 below, more levels are possible. Table 20 shows example properties of the Global User Role object:

TABLE 20

| | |
|---|---|
| Admin- | Administrators typicallyhave create/update/delete permissions to |
| istrator | all Schema Objects and have the right to allocate Permissions to |
| | User-level Schema Users. Administrators have the right to force |
| | the commitment or the cancellation of Changes. |
| User | User-level Schema Users must be allocated all rights to |
| | create/update/delete Schema Objects by explicit Permission, |
| | either from Administrator-level users or from other Users who |
| | have direct or inherited Permissions to the Schema Object in |
| | question. |

Table 21 shows example properties of the Permission Role object:

TABLE 21

| | |
|---|---|
| Owner | Owners have rights to create, update and delete objects they |
| | have an “Ownership” Permission to. |
| | Ownership of Terms inherit to descendant Terms in a |
| | vocabulary. |
| | Ownership of a Content Class inherits to descendant |
| | Content Classes. |
| | Ownership of Element Type-Global Class Permission |
| | allows creation of new Element Types. |
| | Ownership of Vocabulary-Global Class Permission allows |
| | creation of new Vocabularies and Vocabulary Views and |
| | Term Relationship Types. |
| | Direct or inherited ownership of an object conveys rights to |
| | grant other users Permissions on that object. |
| Stakeholder | Stakeholders have voting rights on an object the have |
| | permission to. The level of voting rights is determined by |
| | the prevailing Contract. |
| Subscriber | Subscribers typically have notification rights only. When a |
| | change impacts a Subscriber they are notified by being |
| | allocated a “no-vote” Vote. The vote will be ignored when |
| | Change votes are tallied. |

The Language object is a list of languages and their Local Identifier as discussed above.

The Change object may attain certain states that indicate the process of the change. The Change object and its state are related to but distinct from the Schema Object workstate. (Other states are possible.) Table 22 shows example states of the Change State object:

TABLE 22

| | |
|---|---|
| Initiated | A change has been initiated but impact analysis has |
| | not been performed and votes have not been allocated. |
| Open | A change has been initiated, votes have been allocated |
| | and the voting period is open on the change. |
| Committed | The change has been tallied and passed and the voting |
| | period has either lapsed or does not need to be enforced. |
| | The Change has been implemented in the relevant object |
| | and is now “approved”. |
| Failed | The change has been tallied and failed and the voting |
| | period has either lapsed or does not need to be enforced. |
| | The change has not been implemented and the object |
| | status has been returned to “Approved” status quo ante. |
| Force Commit | The change has been forced to be approved by the |
| | intervention of an Administrator despite the tally failing. |
| Force Cancel | The change has been canceled by an Administrator. |
| Change Error | An error occurred while attempting to log the change. |
| Commit Error | An error occurred while attempting to commit the |
| | change. The Change commit may be retried. |

The Work State object lists certain states that indicate the status of an object. Table 23 shows example states of the Work State object:

TABLE 23

| | |
|---|---|
| Disabled | The object remains in the system for referential integrity |
| | purposes but is no longer available for use. The object is |
| | effectively deleted. |
| Deprecated | The object remains in the system but future use |
| | is discouraged. |
| Approved | The object is an approved standard. The approved state is |
| | the default state for most objects. |
| Pending Add | The object has been added into the system but has not been |
| | approved. This status is normally applied only to new Term |
| | Relationships. |
| Pending | The object has been updated but the update has not been |
| Update | approved by the impacted users. |
| Pending | The object has been flagged for deletion but has not been |
| Delete | deleted pending approval of the impacted users. |
| Pending | The Term has been removed from the vocabulary but the |
| Remove | operation is pending the approval of the impacted users. |
| | Removal indicates the deletion of the Term Relationships |
| | that relate to the term and its descendants in |
| | that vocabulary. |
| Pending | The Term has been moved (a Term Relationship |
| Move | has been added and one has been deleted) |
| | but the add and delete are pending the |
| | approval of the impacted users. |
| Locked | The vocabulary is locked for access by only the |
| | designated user. |
| Open | The Vocabulary is open for updates. No change transaction |
| | will be generated despite impacts. |

Example use of Schema Server

An example is given to describe a potential use of the Schema Server. The example does not, however, provide an exhaustive discussion of all the ways the tool could be utilized. The example does show certain functionality related to the five schema objects which allow for contextualizing schemas. These objects include, Class Element Object, Element Value Object, Vocabulary View Object, Term Value Object, and the Term Relationship Type Object. This is accompanied by a Visio diagram, “Object Model Example-Corporate Merger.”

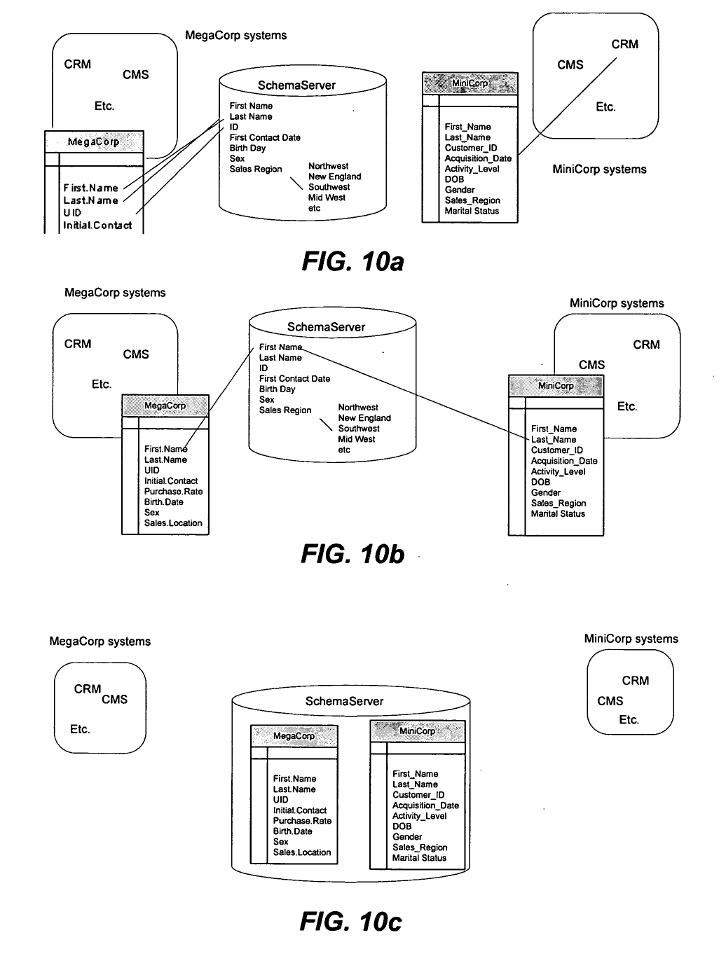

FIG. 10 is a schematic diagram of an example application of a Schema Server Object Model, in accordance with the present invention. In the example of Schema Server, MegaCorp, a theoretical, large corporation, has just acquired a competitor, MiniCorp, a theoretical, small corporation. Among the many tasks facing the new organization is the challenging task of bringing the different information technology tools into alignment so that customer and product information can be shared and ultimately integrated.

Of the many systems involved the customer relationship management (CRM) tools are the first targeted for integration. MegaCorp is currently using a Schema Server object to manage its enterprise schemas. They plan to use Schema Server extensively to model and rationalize the two sets of schemas. MiniCorp has no centralized schema management or repository solution, so its schemas exist in situ. That is to say, each system's schema is represented in the existing systems, but is not described or managed anywhere else.

Step 1—Identify Existing Elements in SchemaServer:

The data integration team finds that the notion of a customer is fairly similar in the two CRM systems. Using a Schema Server, the team is able to consolidate the common data elements. The consolidation process has many different faces as shown in Table 24:

TABLE 24

| Problem | Solution with SchemaServer |
|---|---|
| Many different | Elements from the different systems describing |
| ystems have | similar concepts can be merged into one. The |
| equivalent or similar | Class element object allows for creating local |
| elements that need | names of an element in the context of a Content |
| to be reconciled | Class. Other, non-essential, differences can be |
| | managed and represented using the Class Element |
| | object as well. |
| Need to represent | Elements used in multi-lingual systems can be |
| Element values in | localized using the Element Value Object which |
| different languages | allows for associating different name values per |
| | element per language. |
| Need to be able | Assigning different levels of permissions to |
| to manage the | different users of the Elements and Content |
| change control | Classes. By using the Permission and Contract |
| process | objects the data integration team is able to ensure a |
| | viable, comprehensive, and flexible change |
| | management process. |

Because MegaCorp currently uses a Schema Server to manage and describe its schemas, the schema definitions for MegaCorp's CRM are already described in Schema Server (FIG. 10a). In this first step the elements and content classes in the MiniCorp CRM system are compared to the ones already in SchemaServer. The comparison focuses on concepts described and not just the data structures. For instance there may be elements called Date of Birth and Initial Contact Date. Each of these have the same data type (Date/Time) but they are used to represent different concepts, thus each would be represented by a different element. However, if there were two elements called Birth.Day and BirthDay in the different systems that are used to describe the same concept, then that is a case for merging elements. When doing the comparison the Content Class, Element, and Class Element objects in SchemaServer which represent the MegaCorp elements are used.

As equivalent elements are found they are placed in a content class and the idiosyncratic information (the element name, default value, validation rules, etc) is described in the Class Element object (FIG. 10b).

Table 25 shows some of the elements used in the two systems to describe a customer. As shown in the table, the naming conventions are different and one of the enumerated lists (Vocabularies) is also different. During this first step a Content Class called “Customer” has been created and it has the elements listed in the Schema Server Element Name column in Table 1. This Content Class has two child Content Classes called MegaCorpCustomer and the newly added MiniCorpCustomer. Each of these Content Classes inherits the elements associated with the Customer Content Class. In the Content Class “MiniCorpCustomer” a Class Element object is used to associate the name “First_Name” to the element “FirstName.”

TABLE 25

| SchemaServer | MegaCorp CRM | MiniCorp CRM | | |
|---|---|---|---|---|
| Content Class - | Content Class - | Content Class - | | |
| Customer | Customer | Customer | | |
| Element Name - | Element Name - | Element Name - | Element Data | |
| SchemaServer | MegaCorp | MiniCorp | Type | Element Description |
| FirstName | First.name | First_Name | String - String | The first name of a customer |
| LastName | Last.name | Last_Name | String - String | The current last name of a |
| | | | | customer |
| CustomerUniqueID | UID | Customer_ID | Integer - | A unique number assigned the |
| | | | Integer | first time the person is entered |
| | | | | into the system |
| FirstContactDate | Initial.Contact | Acquisition_Date | Date/Time - | Day the person was entered |
| | | | Date/Time | into the system |
| PurchaseActivity | Purchase.rate | Activity_Level | Vocabulary | Description of the customer's |
| | | | | purchase history. Options |
| | | | | include: |
| | | | | High, Moderate, Low, None - |
| | | | | Active, Occasional, None |
| Birthday | Birth.date | DOB | Date/Time - | Customer date of birth |
| | | | Date/Time | |
| Sex | Sex | Gender | Boolean | 0 = Male, 1 = Female |
| SalesArea | Sales.location | Sales_Region | Vocabulary | By State - By geographic |
| | | | | region (New England, Mid- |
| | | | | West, etc) Mini-Corp has |
| | | | | locations listed in both English |
| | | | | and Spanish |
| | | Marital_Status | Vocabulary | Single, Married, Widow, |
| | | (this is added to | | Widower, Divorced, Annulled, |
| | | the general list of | | |
| | | elements in | | |
| | | SchemaServer) | | |

There are a number of other Elements and Content Classes that are identified and modeled in this process in addition to the Customer Content Class that is discussed in this example.

Step 2—Identify MiniCorp Elements which do not exist in SchemaServer:

In this stage the elements in the MiniCorp System which are not represented in a Schema Server are identified and added as new Elements. Thus the Element from Table 1 called “Marital_Status” would be added to the list of Elements in the Schema Server. It would also be associated with the “MiniCorpCustomer” Content Class.

Step 3—Rationalize the Vocabularies (Enumerated Lists):

Another important part of this consolidation process is the merging and mapping of vocabularies or enumerated lists. The Schema Server's ability to manage and represent vocabularies is used extensively in this part of the integration/mapping process. The two enumerated lists described in the set of elements above both describe similar concepts, but use different terms and in the case of the “Sales_Region” Vocabulary different structures and languages. Using the Schema Server, the integration team is able to both integrate equivalent concepts and map similar ones. This process has many different faces and used a number of different features in a Schema Server as shown in Table 26:

TABLE 26

| Problem | Solution with Schema Server |
|---|---|
| Different terms are used in the | This problem may be solved in a few different ways: |
| Activity_Level enumerated list | The preferable option is to select one enumerated list as |
| | the authoritative list and then add the other terms as |
| | entry terms to the vocabulary |
| | Another preferred option is to maintain the two lists as |
| | different branches in a poly-hierarchical vocabulary and |
| | create links between the appropriate terms. |
| | Another option is to maintain the two unique |
| | vocabularies and create “related term” links between |
| | appropriate terms. This option is better exercised in a |
| | situation where the users need to draw connections |
| | between terms in vocabularies which describe different |
| | concepts. For example, there may be a vocabulary of the |
| | animal kingdom and a vocabulary of biological habitats. |
| | Using the related term relationship a user could draw |
| | links between the habitats and the animals that lived in |
| | the habitats. |
| Both “Activity_Level” vocabularies | Use the Localization (Term Value Object) feature in Schema |
| now need to be in both English and | Server |
| Spanish | |
| The “Sales_Location” vocabularies have | There are a few features in Schema Server which may be used |
| different structures and different levels | to solve this problem: |
| of granularity. | Using the Term Relationship and the Term Relationship |
| | Type objects structure the vocabulary so that the different |
| | levels of granularity can be easily discerned |
| | Using the Vocabulary View object create views which |
| | describe the current needs of the different systems |

The above specification, examples and data provide a complete description of the manufacture and use of the composition of the invention. Since many embodiments of the invention can be made without departing from the spirit and scope of the invention, the invention resides in the claims hereinafter appended.

I claim:

1. A method for localizing terms within schemas using differing relational types, comprising:
storing localized terms values for each object that is to be localized, wherein the localized terms are stored in a container class element that is associated with the object that is to be localized; and
relating an object having localized term values in a container class element to another object wherein the objects are related using one of a hierarchical term and an entry term relationship.
